(19) United States
(12) Patent Application Publication
(10) Pub. No.: US 2012/0029989 A1
(43) Pub. Date: Feb. 2, 2012

(54) LET ME PAY: SYSTEM OF SPONSORSHIP THROUGH TARGETED ADVERTISEMENT

(76) Inventors: Dariusz Jozef Kogut, Warsaw (PL); Krzysztof Adam Kogut, Secaucus, NJ (US)

(21) Appl. No.: 13/263,989

(22) PCT Filed: Apr. 16, 2009
(86) PCT No.: PCT/EP2009/054485

§ 371 Date: Oct. 12, 2011

(51) Int. Cl. G06Q 30/02

(52) U.S. Cl. 705/14.17

(57) ABSTRACT

Let Me Pay is a system invented to help users find sponsors that would pay their bills. In exchange, the sponsors can send targeted advertisements to the users receiving their sponsorship.

Sponsored amounts for goods or services desired by the users would usually be of small value. To receive sponsorship, the user needs to register on users' portal and provide their demographic data. They can send a sponsorship request from a remote terminal, e.g., computer, mobile phone or any other network-capable device with a unique user id, digital certificate or phone number.

The user's request can have a form of a phone call, missed call, instant message, email, click on a web link or any other type of message or communication sent to the system. The system's response to the request carries a targeted advertisement from the sponsor, along with information on the sponsorship terms and conditions. The information is sent to the user's terminal (e.g., computer, mobile phone, PDA).

Content of the targeted advertisement can be generated on the basis of the user's profile, the sponsorship rules, and marketing strategy defined by the sponsor.

The sponsored amount is added to the user's virtual account maintained by the system. It can be transferred to the user's bank account, e-wallet or pre-paid bank card, and spent as real money.

### BRIEF DESCRIPTION OF DRAWINGS

The following description and accompanying drawings disclose various embodiments of the invention.

FIG. 1 illustrates the embodiment of the system components and network environment where the Ads and sponsorships are delivered to the user.

FIG. 2 shows the embodiment of the sponsor registration process, obtaining their budget, marketing strategy, target groups, the Ad content, and activation of the targeted advertising.

FIG. 3 illustrates the embodiment of the user registration process, i.e., obtaining various demographic information about the user, providing them with a choice of available sponsorships, letting them request a sponsorship, providing them with an Ad carrying the sponsorship confirmation, along with fund transfer to their virtual account and letting them transfer the collected funds from the virtual account to an external account or to an e-wallet.

### DETAILED DESCRIPTION

A detailed description of the embodiments of the invention is provided below, along with accompanying figures illustrating its characteristics. The scope of the invention is limited only by the claims. It is not limited to any embodiments provided for the purpose of example.

The invention allows Sponsors to provide advertisements for target groups of users, along with sponsorships for their reasonable expenses. Users can request sponsorships if they meet criteria specified by Sponsors in their marketing strategies. Sponsored amounts are sent to users' accounts, along with confirmation carrying Ads from Sponsors. Users can transfer the received sponsored amounts from their accounts maintained within the system to any external accounts, including but not limited to credit or prepaid bank cards, or money transfers over Internet.

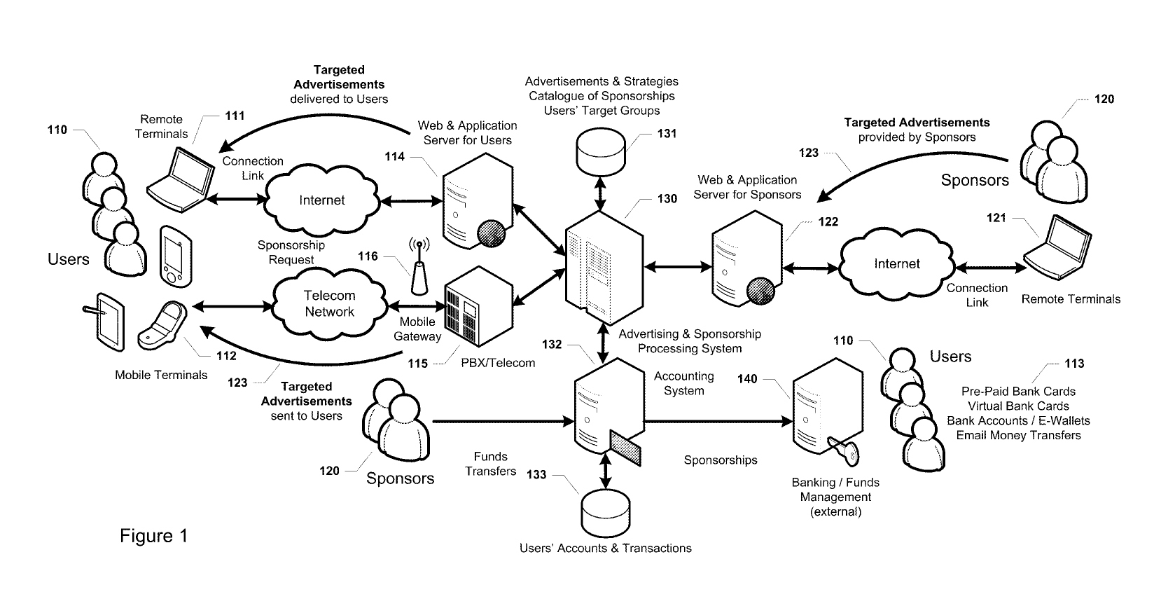

FIG. 1 illustrates the embodiment of the system components and network environment. Users (110) communicate with the system through remote, or mobile terminals (111, 112) connected to the Internet, telecom or other type of network.

Web and Application Server for Users (114), which exchanges information with Advertising & Sponsorship Processing System (130), conducts the user registration process and other tasks performed by users. Web and Application Server for Users (114) provides user interfaces and applications displayed and run on remote, and mobile terminals (111, 112).

PBX/Telecom (115) and Mobile Gateway (116) communicate with users' mobile terminals through a telecom network: they accept requests from users (including sponsorship requests) and provide written or multimedia information (including targeted Ads). Advertising & Sponsorship Processing System (130) collects, maintains and processes the data received from Sponsors (120) and users (110), including but not limited to advertisements strategies, Ad content, catalogues of sponsorships, sponsors and users' profiles and history stored in the database (131).

Web and Application Server for Sponsors (122) conducts the sponsor registration process, and other tasks related to providing advertising strategies, identifying target groups of users, maintaining the marketing budget, providing Ad content and receiving reports. Sponsors (120) communicate with the system through remote terminals (121) connected to the Internet network and further to Web and Application Server for Sponsors (122).

Accounting System (132) maintains Users and Sponsors' accounts and stores the history of financial transactions in the database (133). The system (132) records sponsorship funds provided by Sponsors (120) and coordinates the sponsorship flow to users' accounts. Accounting System executes money transfers from the internal users' accounts to the external accounts (140).

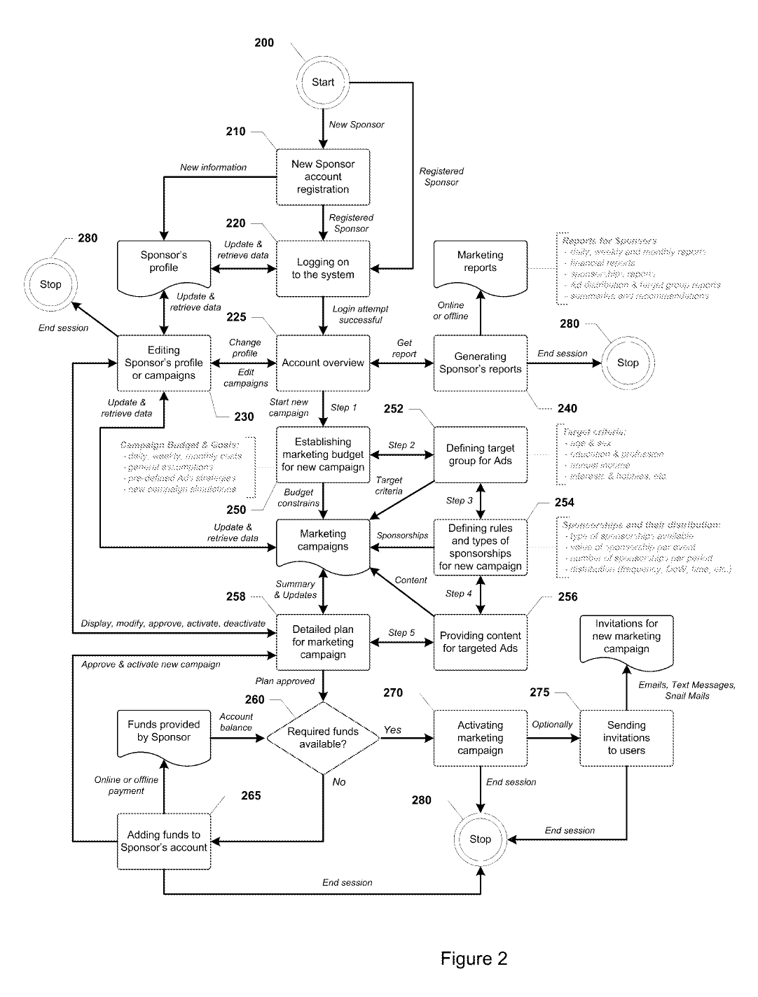

FIG. 2 illustrates the embodiment of the process (200) connected with tasks performed by Sponsors. Sponsor has to register into the system (210) and provide general information about the company, the nature of business, marketing plans, billing information, and other data. Once registered, Sponsor can log into the system (220) and receive an overview of their account, funds, Ads delivered, sponsorships provided to users, or access further options (225).

Sponsor may edit their profile information or marketing campaign properties (230). Sponsor can generate detailed reports concerning the ongoing marketing campaign, Ads and sponsorships sent to users, target groups, budgeting, and other (240). Sponsor can set up a new marketing campaign by providing:
The marketing budget and cost limits per day, week, month and other limits (250),
The demographic and related criteria for the target group of users (252) who would receive Ads and sponsorships, including but not limited to:
   Age
   Sex
   Education
   Profession
   Income
   Location
   Interests and leisure activities
   Marital status/Children
   Other information
The scope and type of sponsorships (usually of small value) from a catalogue of sponsorships (254), or chosen directly by Sponsor, containing general names or brand names and estimated values of goods and services that would benefit users and would strengthen the meaning of the Ad provided along with the sponsored amount. Sponsor indicates the frequency and time the sponsorships are available to the target group of users (including day(s) of the week, time of the day, the number of times daily, weekly, and other parameters).
The content of the Ad in text or multimedia format (256) which, mixed with a confirmation of sponsorship, will be sent to the target users to confirm the sponsorship transfer.
Any additional instructions included in the marketing campaign summary page (258). The summary page should display details of the campaign being set up, including but not limited to the given budget, target groups of users, the scope and type of sponsorships, the content of the Ad to be sent to users, and other information related to the campaign or Sponsor.

If the funds available on the Sponsor's account can finance the new marketing campaign (260), Sponsor can activate the campaign (270) and make it available to the users registered in the system. Sponsor can also send an invitation to individual users, either already registered, or not, to participate in the campaign (275). Sponsor can add funds (265) to continue the ongoing campaign, or to activate a new one.

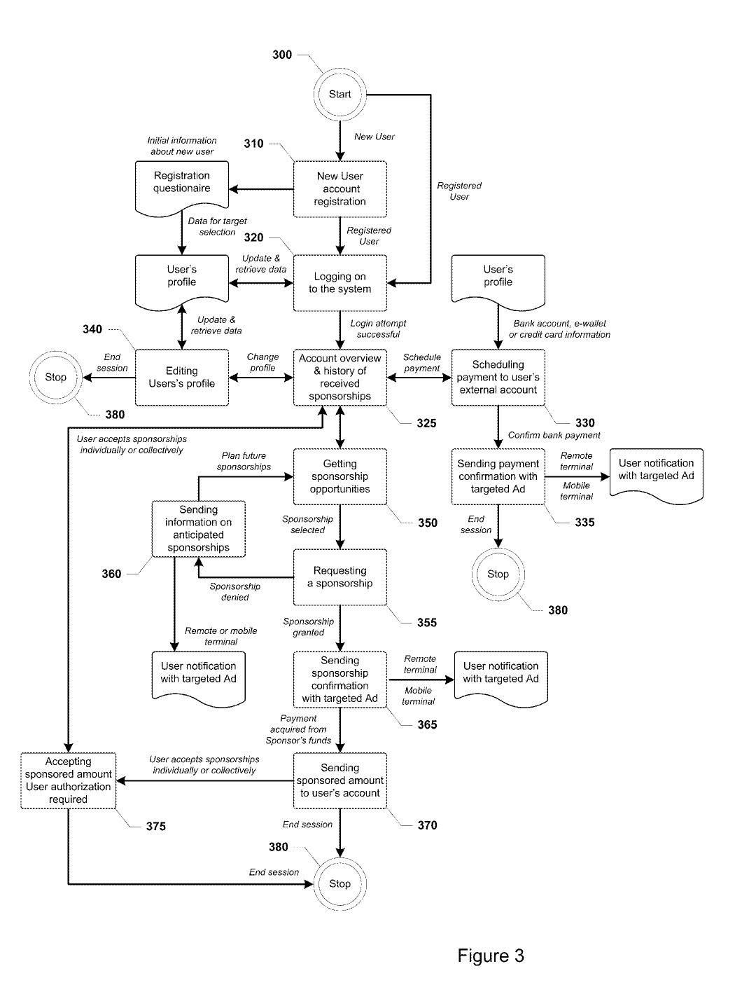

FIG. 3 illustrates the embodiment of the process (300) involving tasks performed by users. The user has to register into the system (310) and provide demographic information, including but not limited to age, sex, education, profession, income, location, interests, marital status, mobile phone number, email address, bank account number for sponsorship transfers, and other. Once registered, the user can access the system (320) and see a summary of his/her account, a list of received sponsorships, with or without Ads, a catalogue of available sponsorships, a short list of selected sponsorships of further interest for the user, and other information related to users, sponsorships or Ads.

After completing the registration process, the user can perform further tasks. The user can request transfer of sponsored funds collected on their internal account to an external one (330) and receive confirmation of such transfer, which may carry a targeted Ad (335). The user can edit his/her profile, refine the collected data and answer any additional questions asked by the system allowing to qualify him/her to a precisely defined target group (340).

The user can request a new sponsorship (355) from a short list, or from a catalogue of available sponsorships (350). Such request can be sent from a remote, or mobile terminal. It can be a type of missed call from a mobile or wired phone, phone call, SMS, MMS, email, instant message, click on web link, or other type of message sent from the user's terminal.

If the user's request meets the sponsorship criteria of one or more marketing campaigns, the user will receive sponsorship confirmation carrying the target Ad from the Sponsor (365) and the sponsored amount will be sent to user's internal account (370). If the user's request does not meet the sponsorship criteria of any active marketing campaign, they will receive notification, which may also carry some information on the nearest anticipated sponsorships (360). The user may be required to accept the sponsorship sent to his/her account (370) by typing an authorization code provided by the system (375).

For clarity purposes, the foregoing embodiments are described in some detail. However, the invention is not limited to the details provided. The disclosed embodiments are of illustrative nature. The invention encompasses numerous alternatives, modifications and equivalents.

1. A method for delivering targeted advertisements (Ads) in return for sponsorship to user's terminal, compromising:
a. collecting users' profiles, demographic data and other information usable for targeted Ads;
b. listing goods or services with relevant cost per unit available for sponsorship;
c. receiving content of targeted Ads, preferred target groups definitions, sponsorship rules and funds for sponsorship from the Sponsor;
d. presenting sponsorship rules to the user;
e. receiving a sponsorship request from the registered user;
f. providing the user with sponsorship confirmation integrated with targeted Ads;
g. making the sponsored amount available to the user (i.e., transferring the amount to user's virtual/internal account);
h. collecting users' bank account numbers in order to transfer the sponsored amounts;
i. providing the users with an option to receive e-wallet, pre-paid bank card, e-cash card, virtual bank card or other kind of account to keep the sponsored amounts;
j. transferring the received sponsored amounts to user's bank account, registered pre-paid card, or to other destination of user's choice listed above;
k. sending confirmation of sponsorship transfer to the user;
l. providing sponsorship reports and targeted Ads reports to the Sponsor.

2. A method as recited in claim 1, wherein the user describes his or her profile and provides demographic data and related information during the registration process and throughout their activity period.

3. A method as recited in claim 1, wherein the user interacts with the system through remote terminal such as mobile phone, PDA, computer or other network-capable device.

4. A method as recited in claim 1, wherein the user receives information about active Sponsors, sponsorship opportunities, previous sponsorships, and balance on user's virtual account via remote terminal;

5. A method as recited in claim 1, wherein the user can interact with other users to exchange information and sponsorship opportunities.

6. A method as recited in claim 1, wherein items on a list of desired goods or services can be defined through examples.

7. A method as recited in claim 6, wherein each item on the list may have a unit cost assigned.

8. A method as recited in claim 6, wherein each item may advertise a brand, manufacturer or reseller;

9. A method as recited in claim 7, wherein the cost of items selected by the user may be paid by the Sponsor.

10. A method as recited in claim 1, wherein the Sponsor provides content of targeted Ads to be delivered to the users of each target group.

11. A method as recited in claim 1, wherein the Sponsor defines preferred target groups of users based on pre-defined criteria.

12. A method as recited in claim 1, wherein the Sponsor defines sponsorship rules managing the delivery of targeted Ads and the sponsored amounts.

13. A method as recited in claim 12, wherein the sponsorship rules are defined via target group, type of goods or services accepted for sponsorship, time and frequency of sponsorship and other terms and conditions.

14. A method as recited in claim 1, wherein the Sponsor provides funds for sponsored amounts transferred to the users when users' requests meet the sponsorship terms and conditions.

15. A method as recited in claim 1, wherein the registered user requests sponsorship through remote terminal.

16. A method as recited in claim 15, wherein such a request can be sent to the system in a form of the following: missed call from mobile or wired phone, phone call, SMS, MMS, email, instant message, click on web link or other type of message sent from user's terminal.

17. A method as recited in claim 15, wherein a request of sponsorship may provide further information about the user in order to refine his or her profile and make them a more precise target for Ads.

18. A method as recited in claim 15, wherein the user receives a system response to his or her request in a form of missed call, phone call, SMS, MMS, email, instant message, browser pop-up window or other type of message sent to user's terminal from the system.

19. A method as recited in claim 18, wherein a system response does not confirm sponsorship if user's profile does not match any of valid sponsorship rules.

20. A method as recited in claim 18, wherein a system response confirms granted sponsorship if the user's profile matches one or more sponsorship rules.

21. A method as recited in claim 18, wherein a system response carries Ads from the Sponsor.

22. A method as recited in claim 21, wherein Ads can be delivered to the user in a form of text, image, movie, sound, brain waves or through other senses, including combined forms.

23. A method as recited in claim 22, wherein the sponsored amount is transferred to user's virtual account maintained in the system after Ads have been sent to the user.

24. A method as recited in claim 23, wherein the transfer may require confirmation with a security code integrated with the Ads sent to the user.

25. A method as recited in claim 1, wherein the registered user can provide his or her bank account number where the funds saved on their virtual account can be transferred.

26. A method as recited in claim 1, wherein the registered user can receive payments or credits to registered e-wallet, pre-paid bank card, e-cash card, virtual bank card or other destination of funds transfer.

27. A method as recited in claim 26, wherein the destination for funds transfers (i.e., e-wallet, pre-paid bank card, e-cash card, virtual bank card or other destination for funds transfer) can carry one or more Ads from the Sponsors.

28. A method as recited in claim 27, wherein the Ads from the Sponsors can be changed or removed, or printed permanently depending on media type and the sponsorship rules.

29. A method as recited in claim 1, wherein the registered user initiates funds transfer from his or her virtual account maintained in the system to a selected destination as mentioned in claims 25 and 26.

30. A method as recited in claim 29, wherein such a request can be sent to the system in a form of the following: missed call from mobile or wired phone, phone call, SMS, MMS, email, instant message or other type of message sent from user's terminal.

31. A method as recited in claim 29, wherein the system transfers the requested amount, if such option is available on user's virtual account, to selected destination using banking services, Internet transactions or related processes.

32. A method as recited in claim 31, wherein the user receives confirmation after the transaction is successfully processed and which may also carry Ads, if included in the sponsorship rules.

33. A method as recited in claim 1, wherein the system generates sponsorship and activity reports for the Sponsors.

34. A method as recited in claim 33, wherein the reports can be sent to the Sponsors or made available on-line on the system portal and may be protected by password.

35. A system of delivering Ads to user's terminal and the sponsored amounts to user's virtual account, compromising:
a. User's terminal or mobile device,
b. Web portal or other type of portal for the users,
c. Web portal or other type of portal for the Sponsors,
d. Transaction system,
e. Communication system,
f. Central database,
g. Sponsors' and system bank accounts integrated with banking services,
h. E-wallet, pre-paid bank card, e-cash card, virtual bank card or other destination of funds transfer, provided by the users.

36. A system as recited in claim 35, wherein a standalone or a remote device can serve as user's terminal, e.g., computer, server terminal, web browser, tablet, PDA, mobile phone, satellite phone, wired phone or other network-capable device.

37. A system as recited in claim 36, wherein user's terminal is connected to network (i.e., the Internet or other local or global network, wired phone or mobile phone network) through data transmitting media such as network cable, fibre, wireless, grps/edge/3G connection, GSM connection, PSTN, ISDN or other type of connection.

38. A system as recited in claim 35, wherein user's terminal sends his or her identification number or other type of identity information to the system, e.g., phone number, user number, digital certificate or other.

39. A system as recited in claim 35, wherein users' portal is a Web portal or other type of portal for potential or registered users and can be a virtual platform for information exchange between the users, the Sponsors and the system.

40. A system as recited in claim 39, wherein users' portal interactively communicates with users' terminals.

41. A system as recited in claim 39, wherein users' portal provides public content for unrestricted access and private content for restricted access to the registered users.

42. A system as recited in claim 39, wherein users' portal conducts user's registration process; can collect any type of information about the users throughout their activity period; shows targeted advertisements, sponsorships status and new sponsorship opportunities, history of user's activity, virtual account operations; can perform other tasks and present other information related to user's activity and sponsorship programmes.

43. A system as recited in claim 35, wherein Sponsors' portal is a Web portal or other type of portal for potential or registered Sponsors or their representatives.

44. A system as recited in claim 43, wherein Sponsors' portal provides public content for unrestricted access and private content for restricted access to the registered Sponsors.

45. A system as recited in claim 43, wherein Sponsors' portal conducts Sponsor's registration process; shows a list of available sponsorships rules and campaign strategies; presents grouped profiles of the registered users; allows the Sponsor to create and manage targeted advertisement programmes and sponsorship rules; allows the Sponsor to manage their marketing budget, provided funds, daily, monthly or other limits of sponsorship expenses per target group of users, reports and conducts other operations related to targeted advertisements, sponsorships and Sponsors' activities.

46. A system as recited in claim 35, wherein a transaction system coordinates all processes and conducts all transactions, data flow operations and information exchange between the system components, the users and the Sponsors.

47. A system as recited in claim 35, wherein a communication system maintains network connection through network cable, fibre, wireless, grps/edge/3G connection, GSM connection, PSTN, ISDN or other type of connection and provides communication channels to transmit data between the system, users' terminals and the Sponsors.

48. A system as recited in claim 35, wherein a central database stores all information processed by the system, i.e., users' profiles, users' virtual accounts, sponsorships statuses, sponsorship opportunities and rules, history of users' activities, payment history, Sponsors' data, advertisements, marketing campaign strategies, reports and other information.

49. A system as recited in claim 35, wherein bank accounts hold funds for the sponsored amounts received from the Sponsors, and the transaction system is integrated with banking services for transferring the sponsored amounts to the users.

50. A system as recited in claim 35, wherein the users can order or register an e-wallet, pre-paid bank card, e-cash card, virtual bank card or other payment instrument where the sponsored amounts can be transferred.
